(19) United States
(12) Patent Application Publication
(10) Pub. No.: US 2009/0103208 A1
(43) Pub. Date: Apr. 23, 2009

(54) MAGNETIC HEAD

(75) Inventors: Kenichiro Aoki, Kawasaki (JP); Toshiyuki Nakada, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/243,428

(22) Filed: Oct. 1, 2008

(30) Foreign Application Priority Data
Oct. 17, 2007 (JP) 2007-270716

(51) Int. Cl. G11B 5/127

(52) U.S. Cl. 360/110; G9B/5.04

(57) ABSTRACT

According to an aspect of an embodiment, a magnetic head includes: a write element including a first magnetic pole and a second magnetic pole magnetically connected to the first magnetic pole; and a nonmagnetic insulating layer made of inorganic material surrounding the write element. The magnetic head further includes: upper and lower low-thermal-expansion material layers disposed on and under the nonmagnetic insulating layer, respectively, the low-thermal-expansion material layers having a thermal coefficient lower than that of the nonmagnetic insulating layer; and a heater element embedded in the nonmagnetic insulating layer.

### CROSS REFERENCE TO RELATED APPLICATIONS

This application is based upon and claims the benefit of priority from the prior Japanese Patent Application No. 2007-270716 filed on Oct. 17, 2007, the entire content of which is incorporated herein by reference.

### BACKGROUND

1. Technical Field

This art relates to storage medium drives, such as a hard disk drive (HDD), and a magnetic head mounded on a head slider incorporated in such a storage medium drive.

2. Description of the Related Art

As disclosed in, for example, Japanese Laid-open Patent Publications No. 2006-196127 and No. Hei-05-20635, heaters associated with magnetic heads are well-known. Such a heater causes the thermal expansion of, for example, a read element and a write element. Accordingly, the read and write elements protrude from one surface of a head slider. The flying height of each of the read and write elements is controlled on the basis of the above-described protrusion. Therefore, a read gap of the read element and a write gap of the write element can be the closest to the surface of a magnetic disk. This results in an increase in magnetic information recording density.

As described above, the read element and the write element thermally expand with increasing the ambient temperature. The thermal expansion causes the read and write elements to protrude. The protrusion causes the read and write elements to come into contact with the magnetic disk, i.e. collide with the magnetic disk. The magnetic disk may be damaged.

Related-art techniques are disclosed in Japanese Laid-open Patent Publication No. 2005-285236 and U.S. Pat. No. 6,963,464 and No. 6,842,308.

### SUMMARY

According to an aspect of an embodiment, a magnetic head includes: a write element including a first magnetic pole and a second magnetic pole magnetically connected to the first magnetic pole; a nonmagnetic insulating layer made of inorganic material surrounding the write element; upper and lower low-thermal-expansion material layers disposed on and under the nonmagnetic insulating layer, respectively, the low-thermal-expansion material layers having a thermal coefficient lower than that of the nonmagnetic insulating layer; and a heater element embedded in the nonmagnetic insulating layer.

### BRIEF DESCRIPTION OF THE DRAWINGS

FIG. 1 is a plan view of the schematic internal structure of a hard disk drive (HDD) according to a first embodiment;

FIG. 2 is an enlarged perspective view of a flying head slider;

FIG. 3 is an enlarged front view of an electromagnetic transducer as viewed from the surface of a transducer built-in layer;

FIG. 4 is a longitudinal sectional view taken along the line 4-4 in FIG. 3;

FIG. 5 is a graph showing the relation between the position of a heating wire and the amount of thermal protrusion and the relation between the position of the heating wire and the rate of decrease;

FIG. 6, corresponding to FIG. 4, is a longitudinal sectional view of an electromagnetic transducer according to a second embodiment;

FIG. 7, corresponding to FIG. 4, is a longitudinal sectional view of an electromagnetic transducer according to a third embodiment; and

FIG. 8, corresponding to FIG. 4, is a longitudinal sectional view of an electromagnetic transducer according to a fourth embodiment.

### DESCRIPTION OF THE PREFERRED EMBODIMENTS

A first embodiment will be described below with reference to the drawings.

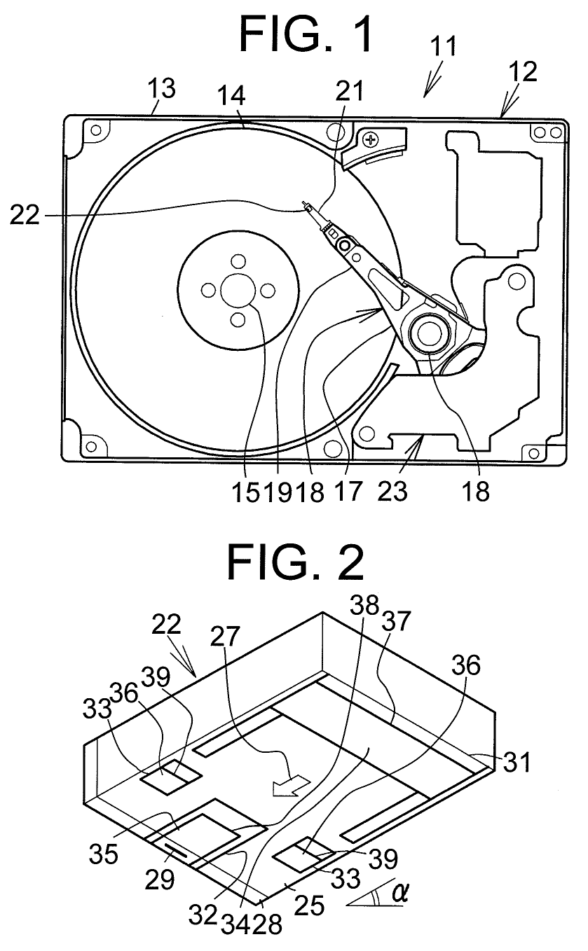

FIG. 1 schematically shows the internal structure of a hard disk drive (HDD) 11 as an example of a storage medium drive. The HDD 11 has a housing 12. The housing 12 includes a box-shaped base 13 and a cover (not shown). The base 13 includes an internal space, i.e. a receiving space having, for example, a flat, rectangular parallelepiped shape. The base 13 may be molded of a metallic material, such as aluminum, by casting. The cover is coupled to an opening of the base 13. The receiving space is sealed between the cover and the base 13. The cover may be made of a single plate by, for example, stamping.

The receiving space receives at least one magnetic disk 14 as a storage medium. The magnetic disk 14 is mounted on the rotating shaft of a spindle motor 15. The spindle motor 15 can rotate the magnetic disk 14 at a high speed, e.g. 5400 rpm, 7200 rpm, 10000 rpm, or 15000 rpm.

The receiving space further receives a carriage 16. The carriage 16 includes a carriage block 17. The carriage block 17 is rotatably coupled with a support shaft 18 extending vertically. The carriage block 17 has at least one carriage arm 19 horizontally extending from the support shaft 18. The carriage block 17 may be molded of aluminum by, for example, extrusion molding.

The tip of the carriage arm 19 is provided with a head suspension 21 such that the head suspension 21 extends forward from the tip of the carriage arm 19. The head suspension 21 is bonded with a flexure. A gimbal is supported on the flexure at the tip of the head suspension 21. The gimbal is mounted with a flying head slider 22. The gimbal allows the flying head slider 22 to change its attitude relative to the head suspension 21. The flying head slider 22 is mounted with a magnetic head, i.e. an electromagnetic transducer.

When air flow is produced on the surface of the magnetic disk 14 by the rotation of the magnetic disk 14, the air flow exerts positive pressure, i.e. buoyancy and negative pressure on the flying head slider 22. The buoyancy and the negative pressure are balanced with a pressing force of the head suspension 21. Thus, the flying head slider 22 is allowed to keep flying with relatively high rigidity during the rotation of the magnetic disk 14.

The carriage block 17 is connected to a power source, such as a voice coil motor (VCM) 23. The VCM 23 permits the carriage block 17 to rotate around the support shaft 18. The rotation of the carriage block 17 allows the carriage arm 19 and the head suspension 21 to swing. When the carriage arm 19 swings around the support shaft 18 during the flight of the flying head slider 22, the flying head slider 22 can traverse over the surface of the magnetic disk 14 in the radial direction thereof. Consequently, the electromagnetic transducer on the flying head slider 22 traverses a data zone between the innermost recording track and the outermost recording track. The electromagnetic transducer can be positioned in a target recording track by the movement of the flying head slider 22.

FIG. 2 illustrates the flying head slider 22. The flying head slider 22 includes, for example, a flat, rectangular parallelepiped base member, i.e. a slider substrate 25. The slider substrate 25 may be made of a hard nonmagnetic material, such as aluminum oxide-titanium carbide (Al₂O₃—TiC: AlTiC). A medium-facing surface, i.e. a flying surface 26 of the slider substrate 25 faces the magnetic disk 14. A flat base plane, i.e. a reference plane is defined on the flying surface 26. When the magnetic disk 14 rotates, air flow 27, which flows from the front end of the slider substrate 25 to the rear end thereof, is exerted on the flying surface 26.

One end face of the slider substrate 25 on the side from which the air flow exits is covered with a nonmagnetic insulating layer, serving as a transducer built-in layer 28. The transducer built-in layer 28 incorporates the electromagnetic transducer, indicated at 29. The transducer built-in layer 28 is made of a relatively soft nonmagnetic insulating material, such as aluminum oxide (alumina: Al₂O₃). The flying head slider 22 includes, for example, a so-called femto-slider. Therefore, the flying head slider 22 has a length of 0.85 mm, a width of 0.7 mm, and a thickness of 0.23 mm.

The flying surface 26 has a single front rail 31 which extends upwardly from the base plane on the upstream side of the above-described air flow 27, i.e. the air entrance side. The front rail 31 extends in the width direction of the slider along one end of the base plane on the air-flow entrance side. The flying surface 26 further has a rear center rail 32 which extends upwardly from the base plane on the downstream side of the air flow, i.e. the air exit side. The rear center rail 32 is disposed in the middle in the width direction of the slider. The rear center rail 32 reaches the transducer built-in layer 28. The flying surface 26 further has a pair of rear side rails 33, 33 disposed on the right and left sides of the surface 26. Each rear side rail 33 extends upwardly from the base plane along the side end of the slider substrate 25 adjacent to the air exit side. The rear center rail 32 is disposed between the rear side rails 33 and 33.

The upper surfaces of the front rail 31, the rear center rail 32, and the rear side rails 33, 33 are defined as air bearing surfaces (ABSs) 34, 35, and 36, 36, respectively. The air bearing surfaces 34, 35, and 36 have steps 37, 38, and 39 in their respective ends on the air entrance side. The steps 37, 38, and 39 are connected to the respective upper surfaces of the front rail 31, the rear center rail 32, and the rear side rails 33. When the flying surface 26 receives the air flow 27, relatively large positive pressure, i.e. buoyancy is generated on the air bearing surfaces 34, 35, and 36 by the steps 37, 38, and 39. Furthermore, large negative pressure is produced at the rear of, i.e. behind the front rail 31. The buoyancy and the negative pressure are balanced with each other to establish the flying attitude of the flying head slider 22.

The rear center rail 32 on the air exit side of the air bearing surface 35 includes the electromagnetic transducer 29. The electromagnetic transducer 29 allows a read gap of a read element or a write gap of a write element to face one surface of the transducer built-in layer 28, as will be described below. The surface of the transducer built-in layer 28 on the air exit side of the air bearing surface 35 may be covered with a hard protective layer. Such a hard protective layer covers the tip of the write gap and that of the read gap exposed to the surface of the transducer built-in layer 28. As for the protective layer, for example, a diamond-like carbon film may be used. The flying head slider 22 is not limited to the above-described structure.

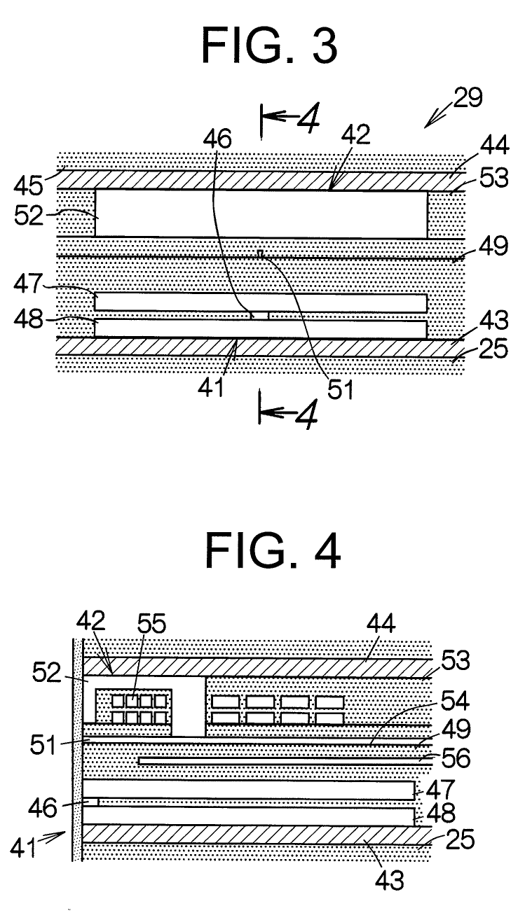

FIG. 3 illustrates the electromagnetic transducer 29 in detail. The electromagnetic transducer 29 includes a read element 41 having, for example, current-perpendicular-to-plane (CPP) structure. As is well known, the CPP structure read element 41 can detect binary information on the basis of a resistance depending on a magnetic field applied from the magnetic disk 14. The CPP structure read element 41 is combined with a write element 42, i.e. a single-pole head element. As is well known, the single-pole head element 42 can write binary information onto the magnetic disk 14 using a magnetic field generated by, for example, a thin-film coil pattern which will be described below. The CPP structure read element 41 and the single-pole head element 42 are disposed between a lower low-thermal-expansion material layer 43 and an upper low-thermal-expansion material layer 44, the lower and upper low-thermal-expansion material layers being made of a material having a low coefficient of thermal expansion. The lower low-thermal-expansion material layer 43 is arranged on the surface of the slider substrate 25. The lower low-thermal-expansion material layer 43, the CPP structure read element 41, the single-pole head element 42, and the upper low-thermal-expansion material layer 44 are covered with an aluminum oxide (Al₂O₃) layer 45 on the surface of the slider substrate 25. The aluminum oxide layer 45 constitutes the above-described transducer built-in layer 28. The lower and upper low-thermal-expansion material layers 43 and 44 are made of a material having a lower coefficient of thermal expansion than a nonmagnetic insulator. The portion surrounding the write element 42 and the read element 41 is composed of the nonmagnetic insulator made of inorganic material such as aluminum oxide (Al₂O₃). As for the material having a lower coefficient of thermal expansion than the nonmagnetic insulator, for example, any one of silicon carbide (SiC), silicon nitride (Si₃N₄), silicon oxide (SiO₂), aluminum nitride (AlN), and tungsten (W) may be used.

The CPP structure read element 41 includes a magnetoresistive layer 46, such as a spin valve layer or a tunnel junction layer. The magnetoresistive layer 46 is sandwiched between an upper electrode 47 and a lower electrode 48. The spacing between the upper electrode 47 and the lower electrode 48 is filled with a nonmagnetic insulator such as aluminum oxide (Al₂O₃) such that the nonmagnetic insulator surrounds the magnetoresistive layer 46. A front end portion of the upper electrode 47 is in contact with the upper interface of the magnetoresistive layer 46 and a front end portion of the lower electrode 48 is in contact with the lower interface thereof, those front end portions being exposed to the surface of the element built-in layer 28. The upper electrode 47 and the lower electrode 48 allow sense current to flow into the magnetoresistive layer 46. In addition to conducting properties, the upper and lower electrodes 47 and 48 may further have soft magnetic properties. When the upper and lower electrodes 47 and 48 are made of a conductive soft magnetic material, such as Permalloy (Ni—Fe alloy), the upper and lower electrodes 47 and 48 can simultaneously function as upper and lower shield layers for the CPP structure read element 41. The upper electrode 47 and the lower electrode 48 define the read gap. The upper electrode 47 and the lower electrode 48 are embedded by a nonmagnetic insulating layer 49 made of a nonmagnetic insulator of inorganic material such as aluminum oxide (Al₂O₃).

The single-pole head element 42 includes a main pole 51 and an auxiliary pole 52 exposed to the surface of the transducer built-in layer 28. The main pole 51 and the auxiliary pole 52 may be made of a conductive soft magnetic material, such as Permalloy. The main pole 51 cooperates with the auxiliary pole 52 to constitute a magnetic core of the single-pole head element 42. The main pole 51 and the auxiliary pole 52 are embedded by a nonmagnetic insulating layer 53 made of a nonmagnetic insulator of inorganic material such as aluminum oxide (Al₂O₃). On the surface of the transducer built-in layer 28, the main pole 51 is separated from the auxiliary pole 52 by a nonmagnetic insulator of inorganic material such as aluminum oxide (Al₂O₃). When a magnetic field is generated by the thin-film coil pattern which will be described below, a magnetic flux leaks from a portion between the main pole 51 and the auxiliary pole 52 on the surface of the transducer built-in layer 28. The leakage magnetic flux forms a recording magnetic field. The single-pole head element 42 of this type is used for so-called perpendicular magnetic recording. In the perpendicular magnetic recording, an easy magnetization axis is established in the vertical direction perpendicular to a recording magnetic layer of the magnetic disk 14. The vertical direction is orthogonal to the surface of a substrate of the magnetic disk 14.

In this embodiment, it is preferable that the lower low-thermal-expansion material layer 43 and the upper low-thermal-expansion material layer 44 have high thermal conductivity. For this purpose, the lower low-thermal-expansion material layer 43 and the upper low-thermal-expansion material layer 44 may be made of, for example, silicon carbide (SiC) or tungsten (W). The lower low-thermal-expansion material layer 43 and the upper low-thermal-expansion material layer 44 each having high thermal conductivity can efficiently dissipate heat from the CPP structure read element 41 and the single-pole head element 42. In particular, it is desirable that the lower electrode 48 be arranged on the surface of the lower low-thermal-expansion material layer 43. With this arrangement, heat generated from the CPP structure read element 41 can be efficiently transferred to the slider substrate 25. It is preferable that the upper low-thermal-expansion material layer 44 be in contact with, for example, the upper surface of the auxiliary pole 52. With this arrangement, heat generated from the single-pole head element 42 can be efficiently transferred to the upper low-thermal-expansion material layer 44.

As shown in FIG. 4, the main pole 51 extends over the surface of the nonmagnetic insulating layer 49, i.e. any reference plane 54. The nonmagnetic insulating layer 49 may be evenly deposited on the upper electrode 47. The nonmagnetic insulating layer 49 interrupts the magnetic coupling between the upper electrode 47 and the main pole 51.

The thin-film coil pattern, indicated at 55, having a double layer structure is arranged above the surface of the main pole 51. Each layer of the thin-film coil pattern 55 is spirally wound along one plane. The thin-film coil pattern 55 is embedded by a nonmagnetic insulator, such as aluminum oxide (Al₂O₃). The auxiliary pole 52 is magnetically coupled with the main pole 51 at the center of the spiral of the thin-film coil pattern 55. Accordingly, part of the thin-film coil pattern 55 is arranged between the main pole 51 and the auxiliary pole 52. The auxiliary pole 52 passes through the center of the spiral of the thin-film coil pattern 55. When current is supplied to the thin-film coil pattern 55, therefore, a magnetic flux passes through the main pole 51 and the auxiliary pole 52.

A heater element is incorporated in the transducer built-in layer 28 so as to be associated with the electromagnetic transducer 29. The heater element includes a heating wire 56 embedded in, for example, the nonmagnetic insulating layer 49. The heating wire 56 may be extended along one plane parallel to the above-described reference plane 54. The heating wire 56 may be made of, for example, titanium tungsten, tungsten, or nickel copper. The heating wire 56 is supplied with electric power, so that the heating wire 56 generates heat. The nonmagnetic insulating layer 49, the thin-film coil pattern 55, the main pole 51, the auxiliary pole 52, the upper electrode 47, and the lower electrode 48 thermally expand in response to the heat. Consequently, the CPP structure read element 41 and the single-pole head element 42 can protrude toward the surface of the magnetic disk 14 during the flight of the flying head slider 22. Accordingly, the heating wire 56 functions as a driving source of an actuator. The width of the heating wire is, for example, 0.1 μm.

During the rotation of the magnetic disk 14, the flying head slider 22 is allowed to face the surface of the magnetic disk 14. Air bearing is formed between the surface of the magnetic disk 14 and the air bearing surfaces 34, 35, and 36. Consequently, the slider substrate 25 rises from the surface of the magnetic disk 14 and flies at a predetermined flying height. In this instance, the heating wire 56 is supplied with electric power from any power supply circuit. Thus, the heating wire 56 generates heat. The CPP structure read element 41 and the single-pole head element 42 thermally expand in response to the heat. Consequently, the transducer built-in layer 28 protrudes toward the magnetic disk 14, thus realizing the “protrusion” of the electromagnetic transducer 29. The read gap of the CPP structure read element 41, the tip of the main pole 51, and that of the auxiliary pole 52 approach the surface of the magnetic disk 14. The flying height of the read gap and that of the main pole 51 are determined on the basis of the amount of protrusion, i.e. the magnitude of thermal expansion. The CPP structure read element 41 reads magnetic information from the magnetic disk 14 in accordance with the flying height determined in the above-described manner. Similarly, the single-pole head element 42 writes magnetic information onto the magnetic disk 14.

It is assumed that the transducer built-in layer 28 thermally expands with increasing, for example, the ambient temperature. Since the lower low-thermal-expansion material layer 43 and the upper low-thermal-expansion material layer 44 have a lower coefficient of thermal expansion than a nonmagnetic insulator of inorganic material (e.g. aluminum oxide) surrounding the write element 42 and the read element 41, the thermal expansion of the lower low-thermal-expansion material layer 43 and that of the upper low-thermal-expansion material layer 44 are more suppressed than that of the nonmagnetic insulator. The lower low-thermal-expansion material layer 43 and the upper low-thermal-expansion material layer 44 remain in their respective positions. Consequently, a reference position for the amount of protrusion can be maintained in a predetermined position upon protrusion of the electromagnetic transducer 29, irrespective of a change in ambient temperature. The amount of protrusion can be controlled with high accuracy. If the lower low-thermal-expansion material layer 43 and the upper low-thermal-expansion material layer 44 are not arranged, the electromagnetic transducer 29 protrudes by a predetermined amount with increasing, for example, the ambient temperature. The above-described “protrusion” is controlled on the basis of the predetermined amount of protrusion. Consequently, the accuracy with which to control the amount of protrusion is lowered. Furthermore, the amount of protrusion is added to the amount of protrusion caused by the heating wire 56. The probability of collision between the electromagnetic transducer 29 and the magnetic disk 14 increases.

In this embodiment, the distance between the heating wire 56 and the upper low-thermal-expansion material layer 44 is set longer than that between the heating wire 56 and the lower low-thermal-expansion material layer 43. With this arrangement, heat generated from the heating wire 56 is more efficiently transferred to the lower low-thermal-expansion material layer 43 than the upper low-thermal-expansion material layer 44. Since the lower low-thermal-expansion material layer 43 is in contact with the slider substrate 25 as described above, heat dissipation by the lower low-thermal-expansion material layer 43 is more accelerated than that by the upper low-thermal-expansion material layer 44 in contact with aluminum oxide layer 45 or air. Therefore, it is more difficult to increase temperature in the lower low-thermal-expansion material layer 43 than in the upper low-thermal-expansion material layer 44. When the heating wire 56 is arranged close to the lower low-thermal-expansion material layer 43, heat can be transferred to the lower low-thermal-expansion material layer 43 as well as to the upper low-thermal-expansion material layer 44. Accordingly, the electromagnetic transducer 29 can protrude maximally. The amount of protrusion of the CPP structure read element 41 can be set equal to that of the single-pole head element 42.

The present inventors verified the amount of protrusion of the CPP structure read element 41 and that of the single-pole head element 42. For the verification, the inventors performed simulations using computer software. In each simulation, the amount of protrusion of the CPP structure read element 41 and that of the single-pole head element 42 were measured. For the measurement, the above-described electromagnetic transducer 29 was modeled. The position of the heater element, i.e. the heating wire 56 was varied, that is, a plurality of positions were set. In a first example, the heating wire 56 was arranged above the lower low-thermal-expansion material layer 43 such that the distance therebetween was 0 μm. In a second example, the heating wire 56 was disposed above the lower low-thermal-expansion material layer 43 such that the distance therebetween was 3.3 μm. This position corresponds to the midpoint between the CPP structure read element 41 and the single-pole head element 42. In a third example, the heating wire 56 was arranged above the lower low-thermal-expansion material layer 43 such that the distance therebetween was 5.0 μm. This position corresponds to the midpoint between the lower layer of the thin-film coil pattern 55 and the main pole 51. In a fourth example, the heating wire 56 was located above the lower low-thermal-expansion material layer 43 such that the distance therebetween was 8.0 μm. This position corresponds to the midpoint between the lower layer of the thin-film coil pattern 55 and the upper layer thereof. In a fifth example, the heating wire 56 was arranged above the lower low-thermal-expansion material layer 43 such that the distance therebetween was 11.0 μm. This position corresponds to the midpoint between the auxiliary pole 52 and the upper low-thermal-expansion material layer 44.

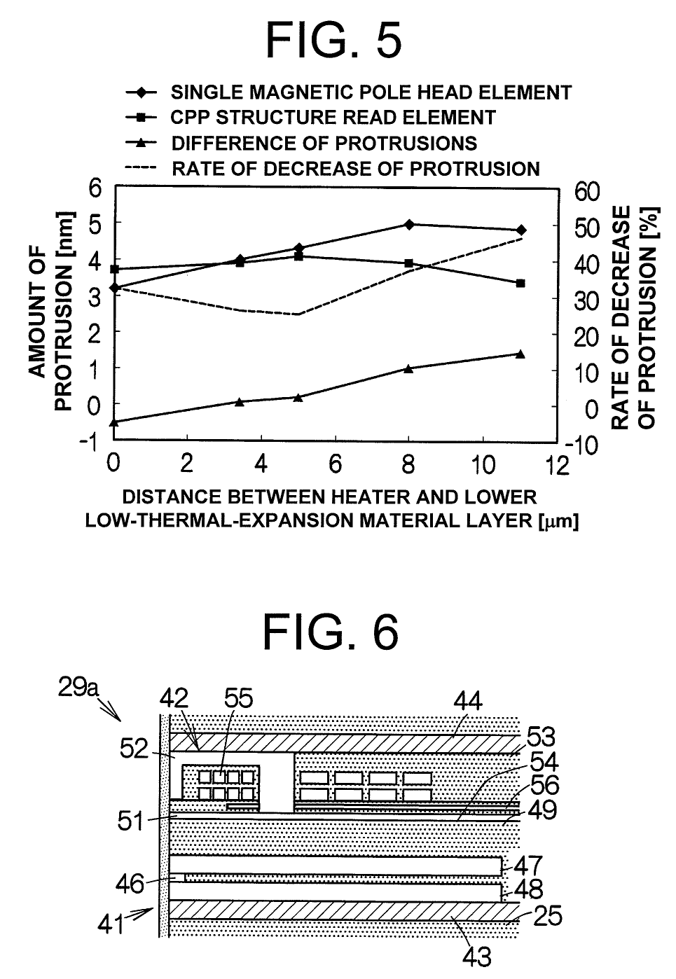

As is clear from FIG. 5, it was found that the amount of protrusion of the single-pole head element 42 increased as the heating wire 56 was closer to the upper low-thermal-expansion material layer 44 and farther away from the lower low-thermal-expansion material layer 43. As for the amount of protrusion of the CPP structure read element 41, a maximum value was recorded when the heating wire 56 was located at the midpoint between the lower low-thermal-expansion material layer 43 and the upper low-thermal-expansion material layer 44. Furthermore, it was found that the difference between the amount of protrusion of the CPP structure read element 41 and that of the single-pole head element 42 was minimized in the range of a distance of 1.0 μm to a distance of 6.0 μm. It is therefore preferable that the heating wire 56 be arranged between the CPP structure read element 41 and the single-pole head element 42 or between the lower layer of the thin-film coil pattern 55 and the main pole 51. When the amount of protrusion of the CPP structure read element 41 is set equal to that of the single-pole head element 42 as described above, each of the CPP structure read element 41 and the single-pole head element 42 can maximally approach the magnetic disk 14. For example, when the amount of protrusion of the single-pole head element 42 is remarkably larger than that of the CPP structure read element 41, the single-pole head element 42 can maximally approach the magnetic disk 14, but the single-pole head element 42 obstructs the approach of the CPP structure read element 41 to the magnetic disk 14. Prior to the approach of the CPP structure read element 41 to the magnetic disk 14, the single-pole head element 42 collides with the magnetic disk 14.

The present inventors simultaneously observed the rate of decrease of the amount of protrusion where the amount of protrusion was greatest with respect to each example. The rates of decrease were calculated with respect to the presence and absence of the lower low-thermal-expansion material layer 43 and the upper low-thermal-expansion material layer 44. Specifically, a decrease in the amount of protrusion of the electromagnetic transducer 29 in the absence of the lower low-thermal-expansion material layer 43 and the upper low-thermal-expansion material layer 44 and that in the presence of those layers were calculated. FIG. 5 plots the rate of decrease with respect to the amount of protrusion of the electromagnetic transducer 29 in the absence of the lower low-thermal-expansion material layer 43 and the upper low-thermal-expansion material layer 44. As is clear from FIG. 5, it was found that the rate of decrease was controlled at a low value in the range from 1.0 to 6.0 μm. Therefore, it is strongly preferable that the heating wire 56 be disposed between the CPP structure read element 41 and the single-pole head element 42 or between the lower layer of the thin-film coil pattern 55 and the main pole 51.

FIG. 6 schematically shows the structure of an electromagnetic transducer 29a according to a second embodiment. In the electromagnetic transducer 29a, the heating wire 56 is arranged between the main pole 51 and the lower layer of the thin-film coil pattern 55. The heating wire 56 may be extended along one plane parallel to the reference plane 54 in the same case as the foregoing first embodiment. The other components equivalent to those in the first embodiment are designated by the same reference numerals. The electromagnetic transducer 29a according to the second embodiment can have the same advantages as those of the electromagnetic transducer 29 according to the first embodiment.

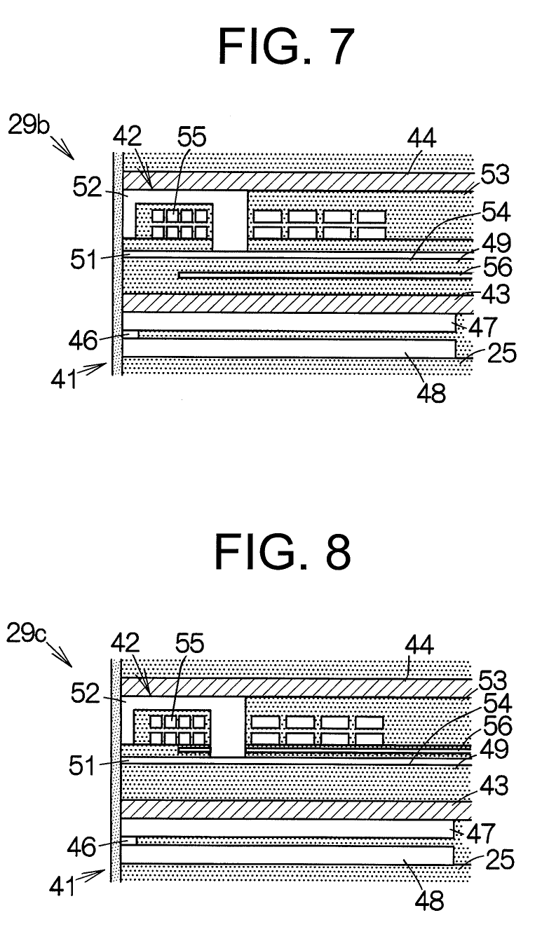

FIG. 7 schematically shows the structure of an electromagnetic transducer 29b according to a third embodiment. In the electromagnetic transducer 29b, the lower low-thermal-expansion material layer 43 is deposited on the upper electrode 47 of the CPP structure read element 41. The nonmagnetic insulating layer 49 is deposited on the lower low-thermal-expansion material layer 43. The heating wire 56 is arranged in the nonmagnetic insulating layer 49 in the same case as the above-described first embodiment. The other components equivalent to those in the first embodiment are designated by the same reference numerals. The electromagnetic transducer 29b according to the third embodiment can have the same advantages as those of the electromagnetic transducer 29 according to the first embodiment.

FIG. 8 schematically shows the structure of an electromagnetic transducer 29c according to a fourth embodiment. In the electromagnetic transducer 29c, the lower low-thermal-expansion material layer 43 is deposited on the upper electrode 47 of the CPP structure read element 41. The nonmagnetic insulating layer 49 is deposited on the lower low-thermal-expansion material layer 43. The heating wire 56 is arranged between the main pole 51 and the lower layer of the thin-film coil pattern 55 in the same case as the foregoing second embodiment. The other components equivalent to those in the second embodiment are designated by the same reference numerals. The electromagnetic transducer 29c according to the fourth embodiment can have the same advantages as those of the electromagnetic transducer 29 according to the first embodiment.

In the above-described electromagnetic transducers 29, 29a, 29b, and 29c, a nonmagnetic insulating layer may be sandwiched between the CPP structure read element 41 and the slider substrate 25. The thickness of such an insulating layer may be set to, for example, 0.3 μm or more. The insulating layer may include a laminate composed of a plurality of sublayers. The insulating layer may include silicon dioxide (SiO₂) or amorphous resin. In addition, a flexible layer may be arranged between the CPP structure read element 41 and the slider substrate 25. Such a flexible layer may have a Young's modulus lower than 50 GPa. The flexible layer may include resist, polyimide, or amorphous fluorocarbon resin. The flexible layer can contribute to the increased amount of protrusion of each of the CPP structure read element 41 and the single-pole head element 42.

Furthermore, the material of the lower low-thermal-expansion material layer 43 may be different from that of the upper low-thermal-expansion material layer 44. In particular, when the thermal conductivity of the lower low-thermal-expansion material layer 43 is set lower than that of the upper low-thermal-expansion material layer 44, the rate of decrease of “protrusion” can be controlled at a low value.

According to an aspect of an embodiment, there is provided a magnetic head including the following elements. A lower low-thermal-expansion material layer has a lower coefficient of thermal expansion than aluminum oxide. A read element, disposed on the lower low-thermal-expansion material layer, faces a medium-facing surface of the magnetic head. A write element, arranged above the read element, includes a first magnetic pole, a second magnetic pole under the first magnetic pole, and a magnetic coil partially sandwiched between the first and second magnetic poles such that the tip of the first magnetic pole and that of the second magnetic pole face the medium-facing surface. An upper low-thermal-expansion material layer, disposed on the write element, has a lower coefficient of thermal expansion than aluminum oxide. A heater element is arranged between the magnetic coil and the lower low-thermal-expansion material layer.

In the magnetic head, the read element and the write element thermally expand due to heat generated from the heater element. Consequently, the read element and the write element protrude from the medium-facing surface of the head. In this manner, the “protrusion” of the read element and that of the write element occur. Thus, the tip of the read element and that of the write element approach a surface of a storage medium. Each of the flying height of the read element and that of the write element is determined on the basis of the amount of protrusion, i.e. the magnitude of thermal expansion. The read element reads magnetic information from the storage medium in accordance with the flying height determined as described above. Similarly, the write element writes magnetic information to the storage medium.

For example, it is assumed that an ambient temperature of the magnetic head increases. Since the lower and upper low-thermal-expansion material layers have a lower coefficient of thermal expansion than aluminum oxide, the thermal expansion of the lower low-thermal-expansion material layer and that of the upper low-thermal-expansion material layer are more suppressed than aluminum oxide. Accordingly, the lower and upper low-thermal-expansion material layers remain in their respective positions. Consequently, a reference position for the amount of protrusion can be maintained in a predetermined position upon protrusion of the read element and the write element, irrespective of a change in ambient temperature. The amount of protrusion can be controlled with high accuracy. The collision of the read element and the write element with the storage medium can be maximally prevented. If the lower low-thermal-expansion material layer and the upper low-thermal-expansion material layer are not arranged, the read element and the write element each protrude by a predetermined amount with increasing, for example, the ambient temperature. The above-described “protrusion” is controlled in accordance with the predetermined amount of protrusion. Consequently, the accuracy with which the amount of protrusion is controlled decreases. The amount of protrusion is added to the amount of protrusion caused by the heater element. The probability of collision between the magnetic head and the storage medium increases.

The magnetic head may further include a substrate that supports the lower low-thermal-expansion material layer. In this case, the distance between the heater element and the upper low-thermal-expansion material layer is set longer than the distance between the heater element and the lower low-thermal-expansion material layer in the magnetic head. With this arrangement, heat generated from the heater element is more efficiently transferred to the lower low-thermal-expansion material layer than the upper low-thermal-expansion material layer. Since the substrate has a higher thermal conductivity than air, heat dissipation by the lower low-thermal-expansion material layer is more accelerated than that by the upper low-thermal-expansion material layer. Therefore, it is more difficult to increase a temperature in the lower low-thermal-expansion material layer than in the upper low-thermal-expansion material layer. When the heater element is arranged close to the lower low-thermal-expansion material layer, heat can be transferred to the lower low-thermal-expansion material layer as well as to the upper low-thermal-expansion material layer. Accordingly, the read element and the write element can protrude maximally. The amount of protrusion of the read element can be set equal to that of the write element. In the case where the amount of protrusion of the read element is set equal to that of the write element as described above, the read element and the write element can maximally approach the storage medium. For example, if the amount of protrusion of the write element is remarkably larger than that of the read element, the write element can maximally approach the storage medium upon writing magnetic information, but the write element obstructs the approach of the read element to the storage medium. Prior to the approach of the read element to the storage medium, the write element collides with the medium.

As for setting the distance, the heater element may be arranged between the second magnetic pole and the read element. Alternatively, the heater element may be arranged between the magnetic coil and the second magnetic pole. In either case, the distance between the heater element and the upper low-thermal-expansion material layer can be set longer than that between the heater element and the lower low-thermal-expansion material layer in the magnetic head.

The lower low-thermal-expansion material layer and the upper low-thermal-expansion material layer may be made of a material having a higher thermal conductivity than aluminum oxide. Preferably, both of the lower low-thermal-expansion material layer and the upper low-thermal-expansion material layer have a high thermal conductivity. The lower and upper low-thermal-expansion material layers having a high thermal conductivity can allow the read element and the write element to efficiently dissipate heat.

According to a second aspect of the present invention, there is provided a magnetic head including the following elements. A lower low-thermal-expansion material layer has a lower coefficient of thermal expansion than aluminum oxide. A read element, disposed under the lower low-thermal-expansion material layer, faces a medium-facing surface of the magnetic head. A write element, arranged above the lower low-thermal-expansion material layer, includes a first magnetic pole, a second magnetic pole under the first magnetic pole, and a magnetic coil partially sandwiched between the first and second magnetic poles such that the tip of the first magnetic pole and that of the second magnetic pole face the medium-facing surface. An upper low-thermal-expansion material layer, disposed on the write element, has a lower coefficient of thermal expansion than aluminum oxide. A heater element is arranged between the magnetic coil and the lower low-thermal-expansion material layer.

In this magnetic head having the above-described structure, the “protrusion” of the read element and that of the write element occur in the same case as the foregoing magnetic head. Each of the flying height of the read element and that of the write element is determined on the basis of the amount of protrusion, i.e. the magnitude of thermal expansion. The read element reads magnetic information from a storage medium in accordance with the flying height determined as described above. The write element similarly writes magnetic information to the storage medium. Furthermore, a reference position for the amount of protrusion can be maintained in a predetermined position upon protrusion of the read element and the write element, irrespective of a change in ambient temperature. The amount of protrusion can be controlled with high accuracy. The collision of each of the read element and the write element to the storage medium can be maximally prevented.

The magnetic head may further include a substrate that supports the lower low-thermal-expansion material layer. In this case, the distance between the heater element and the upper low-thermal-expansion material layer is set longer than that between the heater element and the lower low-thermal-expansion material layer in the magnetic head. Accordingly, the read element and the write element can protrude maximally. The amount of protrusion of the read element can be set equal to that of the write element. In the case where the amount of protrusion of the read element is set equal to that of the write element as described above, the read element and the write element can maximally approach the storage medium. As for setting the distance, the heater element may be arranged between the second magnetic pole and the read element. Alternatively, the heater element may be arranged between the magnetic coil and the second magnetic pole. The lower low-thermal-expansion material layer and the upper low-thermal-expansion material layer may be made of a material having a higher thermal conductivity than aluminum oxide.

The above-described magnetic heads can be mounted on, for example, a particular head slider. The head slider may include a slider substrate and a nonmagnetic insulating layer deposited on a surface of the slider substrate so as to cover the lower low-thermal-expansion material layer, the read element, the write element, the upper low-thermal-expansion material layer, and the heater element. In this case, the lower low-thermal-expansion material layer may be deposited on the surface of the slider substrate. Such a head slider can be incorporated into, for example, a particular storage medium drive. The storage medium drive may include a housing and a head slider incorporated in the housing so as to face a storage medium. In this case, the head slider may have the same structure as that described above.

According to any of the above-described embodiments, the magnetic head capable of preventing collision as much as possible while controlling protrusion can be provided.

What is claimed is:

1. A magnetic head comprising:
a write element including a first magnetic pole and a second magnetic pole magnetically connected to the first magnetic pole;
a nonmagnetic insulating layer made of inorganic material surrounding the write element;
upper and lower low-thermal-expansion material layers disposed on and under the nonmagnetic insulating layer, respectively, the low-thermal-expansion material layers having a thermal coefficient lower than that of the nonmagnetic insulating layer; and
a heater element embedded in the nonmagnetic insulating layer.

2. The magnetic head according to claim 1, further comprising:
a substrate under the lower low-thermal-expansion material layer, wherein the distance between the heater element and the upper low-thermal-expansion material layer is longer than that between the heater element and the lower low-thermal-expansion material layer.

3. The magnetic head according to claim 1, wherein the nonmagnetic insulating layer includes aluminum oxide.

4. The magnetic head according to claim 1, wherein the lower low-thermal-expansion material layer and the upper low-thermal-expansion material layer have a higher thermal conductivity than the nonmagnetic insulating layer.

5. The magnetic head according to claim 2, wherein the substrate have a higher thermal conductivity than the nonmagnetic insulating layer.

6. The magnetic head according to claim 1, further comprising:
a magnetic coil between the first and second magnetic poles, the magnetic coil being capable of inducing a magnetic flux through the first and second magnetic poles.

7. The magnetic head according to claim 6, wherein the heater element is disposed between the magnetic coil and the lower low-thermal-expansion material layer.

8. The magnetic head according to claim 7, wherein the first magnetic pole is above the second magnetic pole and the heater element is disposed between the magnetic coil and the second magnetic pole.

9. The magnetic head according to claim 2, further comprising:
a read element disposed between the lower low-thermal-expansion material layer and the write element.

10. The magnetic head according to claim 9, wherein the first magnetic pole is above the second magnetic pole and the heater element is disposed between the second magnetic pole and the read element.

11. The magnetic head according to claim 2, further comprising:
a read element disposed under the lower low-thermal-expansion material layer.

12. The magnetic head according to claim 11, wherein the heater element is disposed between the second magnetic pole and the lower low-thermal-expansion material layer.

13. A head slider comprising:
a write element including a first magnetic pole and a second magnetic magnetically connected to the first magnetic pole;
a nonmagnetic insulating layer made of inorganic material surrounding the write element;
upper and lower low-thermal-expansion material layers disposed on and under the nonmagnetic insulating layer, respectively, the low-thermal-expansion material layers having a thermal coefficient lower than that of the nonmagnetic insulating layer, the lower low-thermal-expansion material layer being on the substrate;
a substrate under the lower low-thermal-expansion material layer; and
a heater element embedded in the nonmagnetic insulating layer.

14. The head slider according to claim 13, further comprising:
a nonmagnetic insulating layer deposited on the substrate so as to cover the lower low-thermal-expansion material layer, the read element, the write element, the upper low-thermal-expansion material layer, and the heater element.

15. A storage device comprising:
a storage medium; and
a head slider so as to face the storage medium, the head slider including:
a write element including a first magnetic pole and a second magnetic magnetically connected to the first magnetic pole;
a nonmagnetic insulating layer made of inorganic material surrounding the write element;
upper and lower low-thermal-expansion material layers disposed on and under the nonmagnetic insulating layer, respectively, the low-thermal-expansion material layers having a thermal coefficient lower than that of the nonmagnetic insulating layer, the lower low-thermal-expansion material layer being on the substrate;
a substrate under the lower low-thermal-expansion material layer; and
a heater element embedded in the nonmagnetic insulating layer.

16. The storage device according to claim 15, wherein the head slider further includes a nonmagnetic insulating layer deposited on the substrate so as to cover the lower low-thermal-expansion material layer, the read element, the write element, the upper low-thermal-expansion material layer, and the heater element.
